(19) United States
(12) Patent Application Publication
(10) Pub. No.: US 2008/0101900 A1
(43) Pub. Date: May 1, 2008

(54) SIDE DISMOUNT APPARATUS

(75) Inventor: Ed W. Harber, Noblesville, IN (US)

Correspondence Address: ICE MILLER LLP, ONE AMERICAN SQUARE, SUITE 3100, INDIANAPOLIS, IN, 46282-0200, US

(73) Assignee: Truss Partners, LLC (an Indiana limited liability company), Westfield, IN (US)

(21) Appl. No.: 11/555,186

(22) Filed: Oct. 31, 2006

(51) Int. Cl. B60P 1/04

(52) U.S. Cl. 414/470

(57) ABSTRACT

A side dismount apparatus and method of making and using the same, and in particular, to such side dismount apparatus coupled to a transport vehicle. In an embodiment of the present disclosure, a side dismount apparatus for unloading construction materials from the side of a transport vehicle comprises at least two telescoping arm assemblies, the at least two telescoping arm assemblies each comprising an outer arm having a lower surface and a lower arm, the lower surface of the outer arm slidingly engaged with the lower arm, a rotatable substantially cylindrical drive shaft having a longitudinal axis, and a gear concentric with the longitudinal axis of the drive shaft so that rotation of the drive shaft rotates the gear, the gear comprising teeth for engaging the lower surface of the outer arm of at least one of the at least two telescoping arm assemblies, whereby rotation of the drive shaft is operable to extend and retract the outer arm from at least one of the at least two telescoping arm assemblies.

### BACKGROUND

Due to increasing Environmental Protection Agency (EPA) regulations and fines for tracking dirt and/or mud onto the streets in residential subdivision developments, delivery of construction materials to a construction site has become somewhat complicated. After delivery, and especially during wet weather conditions, mud is tracked onto the streets thereby creating potential environmental damage. Those building new homes, as well as those residing in an area where construction is ongoing, were demanding a method of delivering trusses or other construction materials whereby the vehicle used to transport such materials would not track dirt and/or mud onto the streets after the delivery of the materials.

Delivery of construction materials to a construction site is typically performed by one of three methods. The first method is a typical delivery of materials by truck, van, semi-trailer truck, or another transport vehicle, to a location on the construction site close to the ultimate location of use of the materials. For example, a delivery of tile and adhesive to a new residential home construction site may be made by van, whereby the van drives onto the property and the tile is unloaded near the garage of the new house. While this method of delivery may deliver the materials at or near the location of ultimate use, this method may also require the transport vehicle to drive on an area of the property without a road, driveway, gravel, or grass, and may result in the unfavorable and perhaps inevitable tracking of dirt and/or mud onto the street once the vehicle exits the construction site property. This dirt and/or mud may then, over time, enter into the storm drainage system, causing blockages, overflows, and other environmental hazards.

The second method is the delivery of materials at or near the curb of the construction site. For example, a delivery of bricks may be delivered to the street in front of the construction site using a forklift. This method of delivery may not require a vehicle to drive onto the property itself, which would not result in the tracking of dirt and/or mud from the construction site property into the street. However, this method of delivery would result with construction materials residing in the street, causing a potential hazard to drivers in that area, children playing in that area, and may also result in increased theft of construction materials given the easy access to the materials. This method also generally does not allow for the materials to be placed at or near the ultimate location of use, and as in the example referenced, the bricks would then need to be transported from the street to a location closer to the actual structure utilizing the bricks, resulting in additional labor costs and time during construction.

The third method is the delivery of materials to the construction site using a mini boom/crane or a similar apparatus as known in the art. For example, a delivery of shingles and roof tar may be made directly from a semi-trailer truck parked in the street in front of the property directly to the roof of the structure by a mini boom/crane or other means. This method may also not result in the tracking of dirt and/or mud from the construction site into the street, but would typically be a much higher cost option than the traditional delivery of materials, requiring the use of additional costly equipment and labor to make such a delivery. The use of a mini boom/crane may also create problems in obtaining liability insurance during construction, as the use of such an apparatus introduces an additional level of risk of potential injury to construction workers and/or property when in use.

To help minimize erosion and the tracking of dirt and/or mud from the construction site onto the streets, construction sites may utilize silt fences and/or coconut logs at or near the perimeter of the construction site property. Silt fences and/or coconut logs may act to prohibit soil from eroding from the property, by wind, rain, or general tracking of dirt and/or mud, by acting as a physical barrier to retain some or all of the eroded soil. In addition, silt fences and/or coconut logs may prohibit certain vehicles from entering the construction site at that location, and the removal and reinstallation of silt fences and/or coconut logs if moved for a delivery may also result in an additional construction expense.

Given the aforementioned delivery limitations, a system and/or method for delivering construction materials to a construction site would be beneficial. For the foregoing reasons, there is a need for an apparatus for the delivery of construction materials to a construction site without tracking dirt and/or mud onto the streets.

### BRIEF SUMMARY

This invention relates to a side dismount apparatus and method of making and using the same, and in particular, to such side dismount apparatus coupled to a transport vehicle.

According to an embodiment of the present disclosure, a side dismount apparatus for unloading construction materials from the side of a transport vehicle is disclosed, the side dismount apparatus comprising at least two telescoping arm assemblies, the at least two telescoping arm assemblies each comprising an outer arm having a lower surface and a lower arm, the lower surface of the outer arm slidingly engaged with the lower arm, a rotatable substantially cylindrical drive shaft having a longitudinal axis, and a gear concentric with the longitudinal axis of the drive shaft so that rotation of the drive shaft rotates the gear, the gear comprising teeth for engaging the lower surface of the outer arm of at least one of the at least two telescoping arm assemblies, whereby rotation of the drive shaft is operable to extend and retract the outer arm from at least one of the at least two telescoping arm assemblies.

In another embodiment of a side dismount apparatus, each of the at least two telescoping arm assemblies further comprises an inner arm positioned within the outer arm. In an additional embodiment, a side dismount apparatus further comprises at least one piston assembly coupled to at least one of the at least two telescoping arm assemblies, the at least one piston assembly comprising a piston housing, a piston coupled to the inner arm and positioned within the piston housing, and a piston movement mechanism operably coupled to the at least one piston assembly.

In another embodiment of a side dismount apparatus, the lower surface of at least one of the outer arms defines gear apertures sized and shaped to receive the teeth of the gear. In yet another embodiment, a side dismount apparatus further comprises individual chain links coupled to the lower surface of at least one of the outer arms, the individual chain links defining individual chain apertures, the individual chain apertures sized and shaped to receive the teeth of the gear. In an additional embodiment, a side dismount apparatus further comprises a motor operable to rotate the drive shaft.

In another embodiment of a side dismount apparatus, the side dismount apparatus is removably coupled to the transport vehicle. In an additional embodiment, a side dismount apparatus further comprises a dismount piston assembly coupled to a transport vehicle. In another embodiment, a side dismount apparatus further comprises at least one hinge coupled to at least one of the at least two telescoping arm assemblies. In yet another embodiment of the present disclosure, a side dismount apparatus further comprises a joining member comprising a shaft portion, a first portion of the shaft portion coupled to a first end of the piston, and a second portion of the shaft portion coupled to a first end of the inner arm.

According to an embodiment of the present disclosure, a transport vehicle for unloading construction materials from the side of the transport vehicle is disclosed, the transport vehicle comprising a side dismount apparatus removably coupled to the transport vehicle, the side dismount apparatus comprising at least two telescoping arm assemblies, the at least two telescoping arm assemblies each comprising an outer arm having a lower surface and a lower arm, the lower surface of the outer arm slidingly engaged with the lower arm, a rotatable substantially cylindrical drive shaft having a longitudinal axis, and a gear concentric with the longitudinal axis of the drive shaft so that rotation of the drive shaft rotates the gear, the gear comprising teeth for engaging the lower surface of the outer arm of at least one of the at least two telescoping arm assemblies.

In another embodiment of a transport vehicle, each of the at least two telescoping arm assemblies further comprises an inner arm positioned within the outer arm. In an additional embodiment, a transport vehicle further comprises at least one piston assembly coupled to at least one of the at least two telescoping arm assemblies, the at least one piston assembly comprising a piston housing, a piston coupled to the inner arm and positioned within the piston housing, and a piston movement mechanism operably coupled to the at least one piston assembly.

In another embodiment of a transport vehicle, the lower surface of the outer arm defines gear apertures sized and shaped to receive the teeth of the gear. In yet another embodiment, a transport vehicle further comprises a motor operable to rotate the drive shaft. In an additional embodiment of the present disclosure, a transport vehicle further comprises at least one support member, the at least one support member defining an inner surface sized and shaped to rotatably receive the drive shaft.

In another embodiment of a transport vehicle of the present disclosure, a transport vehicle further comprises at least one hinge coupled to at least one of the at least two telescoping arm assemblies. In yet another embodiment, a transport vehicle further comprises a dismount piston assembly coupled to the transport vehicle. In an additional embodiment, a transport vehicle further comprises a locking clip coupled to the transport vehicle.

According to an embodiment of the present disclosure, a transport vehicle for unloading construction materials from the side of the transport vehicle is disclosed, the transport vehicle comprising a side dismount apparatus removably coupled to the transport vehicle, the side dismount apparatus comprising least two telescoping arm assemblies, the at least two telescoping arm assemblies each comprising an outer arm having a lower surface, a lower arm slidingly engaged with the lower surface of the outer arm, and an inner arm positioned within the outer arm, at least one piston assembly coupled to at least one of the at least two telescoping arm assemblies, the at least one piston assembly comprising a piston housing, a piston coupled to the inner arm and positioned within the piston housing, and a piston movement mechanism operably coupled to the at least one piston assembly, a rotatable substantially cylindrical drive shaft having a longitudinal axis, at least one support member, the at least one support member defining an inner surface sized and shaped to rotatably receive the drive shaft, a gear concentric with the longitudinal axis of the drive shaft so that rotation of the drive shaft rotates the gear, the gear comprising teeth for engaging the lower surface of the outer arm of at least one of the at least two telescoping arm assemblies, a motor operable to rotate the drive shaft, at least one hinge coupled to at least one of the at least two telescoping arm assemblies, and a dismount piston assembly coupled to the transport vehicle.

### BRIEF DESCRIPTION OF THE DRAWINGS

The features and advantages of this disclosure, and the manner of attaining it, will be more apparent and better understood by reference to the following descriptions taken in conjunction with the accompanying drawings, wherein:

FIG. 1 shows a top view of an embodiment of a side dismount apparatus of the present disclosure;

FIG. 2 shows a top view of the embodiment of FIG. 1 with two pistons and two inner arms extended;

FIG. 3 shows a top view of the embodiment of FIG. 1 with four pistons and four inner arms extended;

FIG. 4 shows a front view of an embodiment of a telescoping arm assembly according to the present disclosure;

FIG. 5 shows a rear view of an embodiment of a telescoping arm assembly according to the present disclosure;

FIG. 6a shows a front perspective view of an embodiment of a telescoping arm assembly along with a drive shaft, a gear, and at least one support member according to the present disclosure;

FIG. 6b shows a front perspective view of an embodiment of one of a telescoping arm assembly along with a drive shaft, a gear, and at least one support member according to the present disclosure;

FIG. 7 shows a rear perspective view of an embodiment of one of a telescoping arm assembly along with an engaged locking clip according to the present disclosure;

FIG. 8 shows a rear perspective view of the embodiment of FIG. 7 with a disengaged locking clip;

FIG. 9 shows a rear view of an embodiment of a transport vehicle with a side dismount apparatus coupled to the trailer bed and construction materials resting on the side dismount apparatus according to the present disclosure;

FIG. 10 shows a rear view of the embodiment of FIG. 9 with an inner arm extended;

FIG. 11 shows a rear view of the embodiment of FIG. 9 with an inner arm and an outer arm extended;

FIG. 12 shows a rear view of the embodiment of FIG. 9 with the telescoping arm assemblies rotated about at least one hinge so that the construction materials and/or the inner arm contact the ground;

FIG. 13 shows a rear view of the embodiment of FIG. 9 with an inner arm and an outer arm retracting to allow for the construction materials to be deposited on the ground;

FIG. 14 shows a rear view of the embodiment of FIG. 9 with the side dismount apparatus returning to its initial position and the construction materials deposited on the ground;

FIG. 15 shows a rear view of an embodiment of a transport vehicle with a side dismount apparatus coupled to the trailer bed and construction materials resting on the side dismount apparatus with the telescoping arm assemblies rotated about at least one hinge so that the construction materials and/or the inner arm contact the ground according to the present disclosure;

FIG. 16 shows a rear view of the embodiment of FIG. 15 with an inner arm and an outer arm retracting to allow for the construction materials to be deposited on the ground; and

FIG. 17 shows a rear view of the embodiment of FIG. 15 with the side dismount apparatus returning to its initial position and the construction materials deposited on the ground; and

FIG. 18 shows a side perspective view of an embodiment of a transport vehicle with a side dismount apparatus coupled to the trailer bed and a dismount piston assembly coupled thereto according to the present disclosure.

### DETAILED DESCRIPTION

The present disclosure includes disclosure of a side dismount apparatus and method of making and using the same. For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A side dismount apparatus according to at least one of the embodiments disclosed herein allows drivers to keep their transport vehicles on the street and park parallel to the curb of the property. Trusses or other construction materials can then be unloaded over the silt fence and/or coconut logs and directly onto the construction site, thereby eliminating contact with the dirt and/or mud on the construction site property.

One benefit to a side dismount apparatus according to the present disclosure is that no existing transport vehicle allows for trusses or other typically large construction materials to be unloaded from the side versus the rear of the transport vehicle. By being able to unload from the side, the transport vehicle will not come into contact with any dirt and/or mud at the construction site, thereby greatly enhancing erosion control. An additional benefit is that minimal moving parts may decrease the overall costs associated with building and maintaining a side dismount apparatus. A third benefit is that a side dismount apparatus can be built for less than either a conventional roll-off trailer or mini boom/crane. In addition, the delivery of construction materials, like trusses, using a side dismount apparatus may result in less damage to the individual trusses as compared to delivery using a standard roll-off trailer. Furthermore, and as set forth herein, a side dismount apparatus according to the present disclosure should reduce the problems caused by dirt and/or mud in the streets and the resulting potential environmental damage associated therewith.

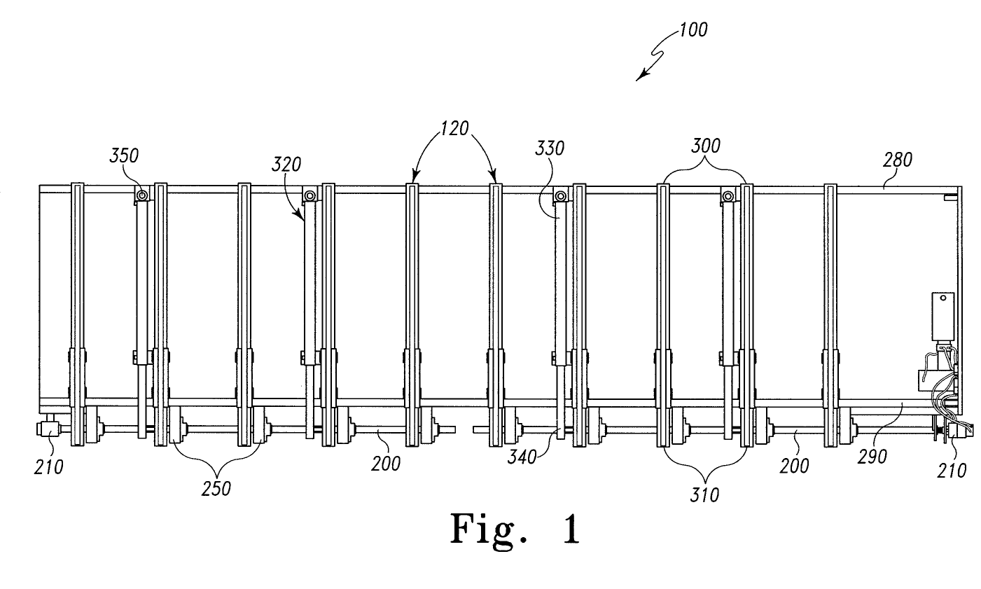

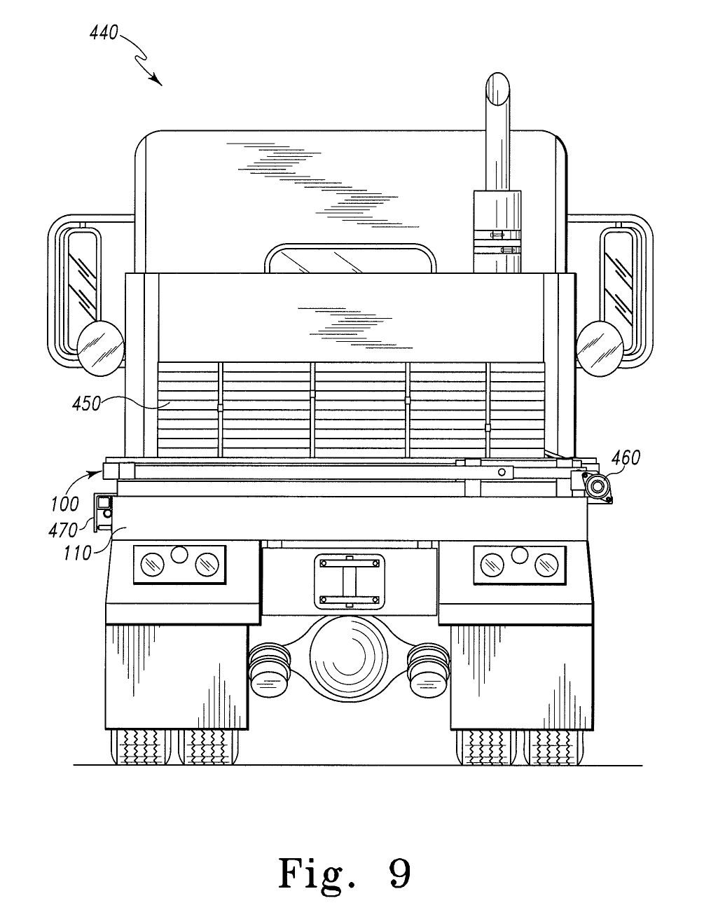

Referring now to FIG. 1, a side dismount apparatus 100 according to at least one embodiment of the present disclosure is shown. The side dismount apparatus 100 may be fixedly or removably coupled to a trailer bed 110 (shown in FIGS. 9-14).

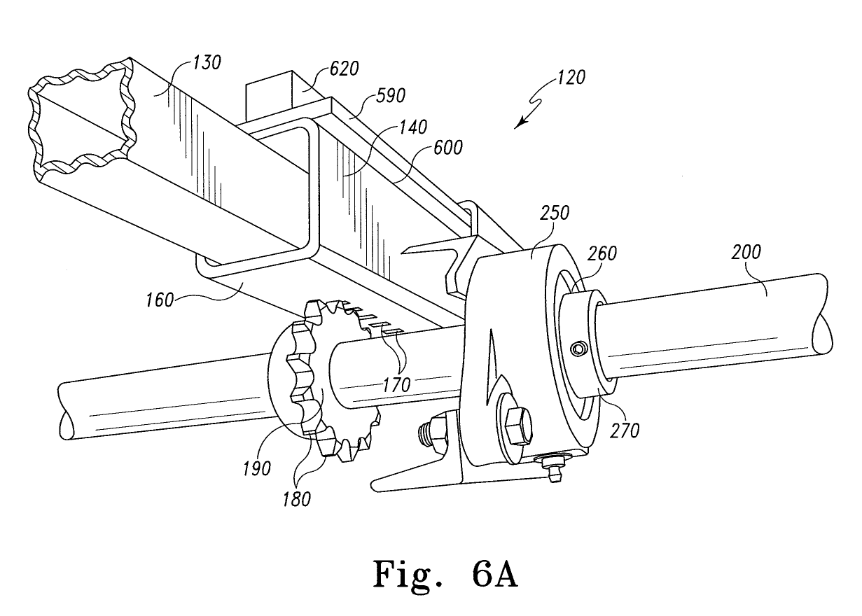

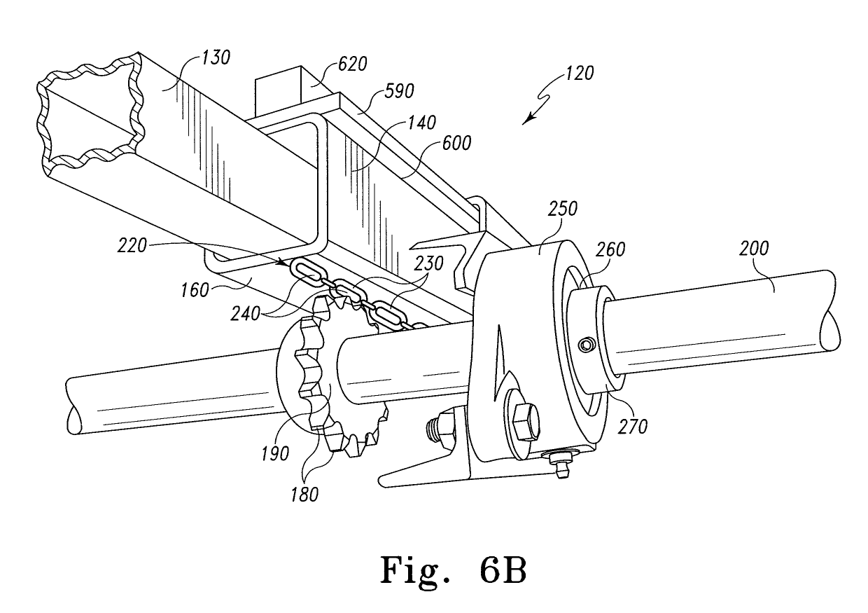

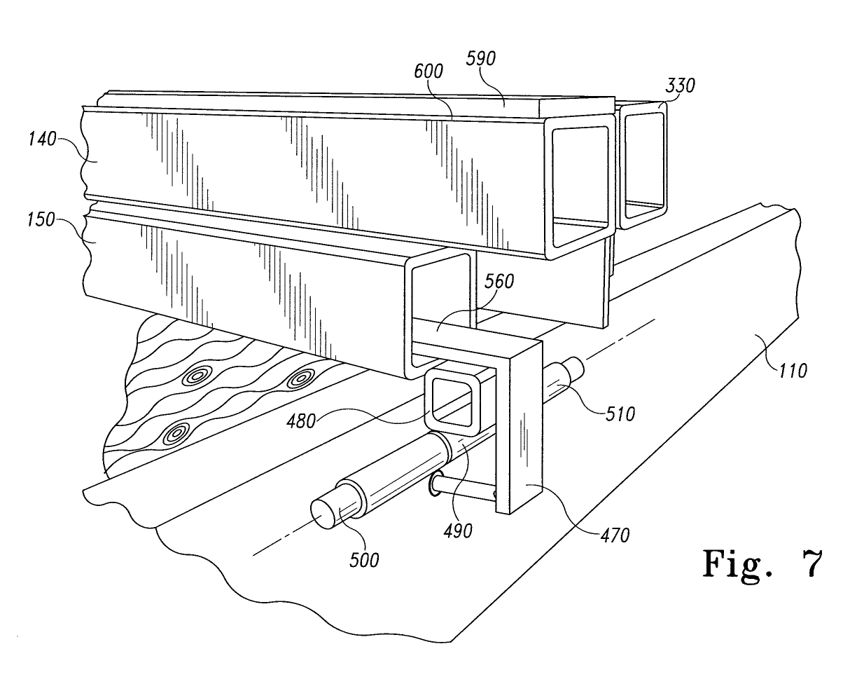

The side dismount apparatus 100 comprises telescoping arm assemblies 120. An embodiment of one of the telescoping arm assemblies 120 is shown in FIGS. 6a and 6b. Each of the telescoping arm assemblies 120 may comprise an inner arm 130 and an outer arm 140. In this embodiment, the inner arm 130 is positioned within the outer arm 140. Each of the telescoping arm assemblies 120 may further comprise a lower channel arm 150 (shown in FIG. 7). The lower channel arm 150 may be sized and shaped to support the outer arm 140 telescoping arm assemblies 120.

A lower surface 160 of the outer arm 140 may define gear apertures 170 which may span a specified distance along the lower surface 160 of the outer arm 140. The gear apertures 170 may be sized and shaped to receive teeth 180 positioned around the circumference of a gear 190. Gear 190 may be fixedly or removably coupled to a drive shaft 200. Gear 190 may also be concentric with the longitudinal axis of the drive shaft 200 so that rotation of the drive shaft rotates the gear 190. The drive shaft 200 may be rotatably coupled to a motor 210 (shown in FIGS. 1-3). The drive shaft 200 may also be substantially cylindrical having a longitudinal axis. In an alternative embodiment, a chain 220 (shown in FIG. 6b) comprising individual chain links 230 defining individual chain apertures 240 may be fixedly coupled to the lower surface 160 of the outer arm 140. In this alternative embodiment, the chain 220 may be welded to the lower surface 160 of the outer arm 140, and the individual chain apertures 240 may be sized and shaped to receive teeth 180 positioned around the circumference of a gear 190. In an additional embodiment, individual chain links 230 defining individual chain apertures 240 may be fixedly coupled to the lower surface 160 of the outer arm 140.

As shown in FIGS. 6a and 6b, the outer arm 140 may be extended from the telescoping arm assemblies 120 by operation of the motor 210. The motor 210 may operate to rotate gear 190 coupled to the drive shaft 200 in a first direction, causing the gear 190 to extend the outer arm 140 from the telescoping arm assemblies 120. The motor 210 may also operate to rotate gear 190 coupled to the drive shaft 200 in a second direction opposite the first direction, causing the gear 190 to retract the outer arm 140 into the telescoping arm assemblies 120. The motor 210 may be operated using a motor computer (not shown) or another device to operate the motor 210. The teeth 180 of the gear 190 may be positioned within the gear apertures 170 on the lower surface 160 of the outer arm 140, and the rotation of the gear 190 may cause the teeth 180 to contact the gear apertures 170, causing the outer arm 140 to extend from the telescoping arm assemblies 120. If a chain 220 is positioned on the lower surface 160 of the outer arm 140, the teeth 180 of the gear 190 may be positioned within the individual chain apertures 240 of the chain 220, and the rotation of the gear 190 may cause the teeth 180 to contact the chain 220 at the individual chain apertures 240, causing the outer arm 140 to extend from the telescoping arm assemblies 120. Additional means for allowing teeth 180 of a gear 190 to engage the lower surface 160 of the outer arm 140 may be considered that do not utilize gear apertures 170 on the outer arm 140 or a chain 220 coupled to the outer arm 140.

Referring back to FIGS. 1-3, the drive shaft 200 may be supported by at least one support member 250 coupled to the trailer bed 110. The at least one support member 250 may define an inner surface 260 (as shown in FIGS. 6a and 6b), allowing the drive shaft 200 to be rotatably positioned within the at least one support member 250. In one embodiment, the at least one support member 250 may further comprise a cuff 270 removably or fixedly coupled to the inner surface 260 of the at least one support member 250, wherein the drive shaft 200 is rotatably positioned within the inner surface 260 of the cuff 270.

An exemplary embodiment of a side dismount apparatus 100 is shown in FIGS. 1-3. In this exemplary embodiment, the telescoping arm assemblies 120 comprises ten telescoping arm assemblies 120. In an additional embodiment, the telescoping arm assemblies 120 comprises seven telescoping arm assemblies 120. The embodiment shown in FIGS. 1-3 further comprises support members 250. In an exemplary embodiment, the telescoping arm assemblies 120 are spaced approximately 6 feet to 8 feet apart. The side dismount apparatus 100 may further comprise a first longitudinal support 280 and a second longitudinal support 290. The first longitudinal support 280 and the second longitudinal support 290 may be fixedly or removably coupled to a first end 300 and/or a second end 310 of the telescoping arm assemblies 120. The coupling of the first longitudinal support 280 and/or the second longitudinal support 290 to the telescoping arm assemblies 120 may provide stability and support for the side dismount apparatus 100 as coupled to the trailer bed 110. In the embodiment shown in FIGS. 1-3, the first end 300 of each of the telescoping arm assemblies 120 is coupled to the first longitudinal support 280, the second end 310 of each of the telescoping arm assemblies 120 is coupled to the second longitudinal support 290.

In the embodiment shown in FIGS. 1-3, the side dismount apparatus 100 comprises two drive shafts 200, two motors 210, and a plurality of at least one support members 250. In at least one other embodiment, the side dismount apparatus 100 may comprise any number of drive shafts 200, motors 210, and at least one support member 250 as suitable for the particular application.

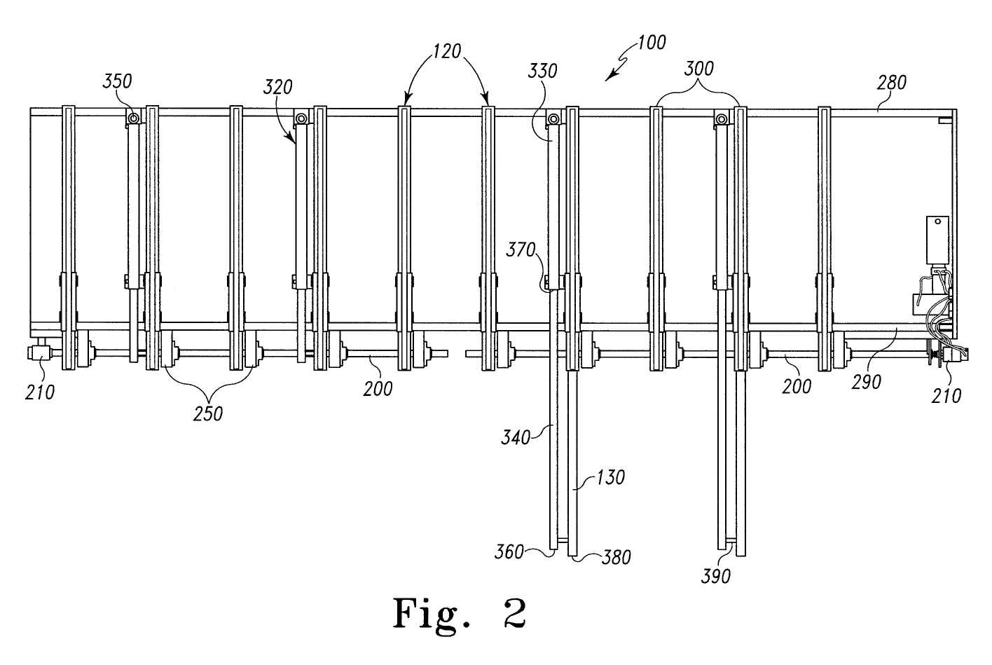

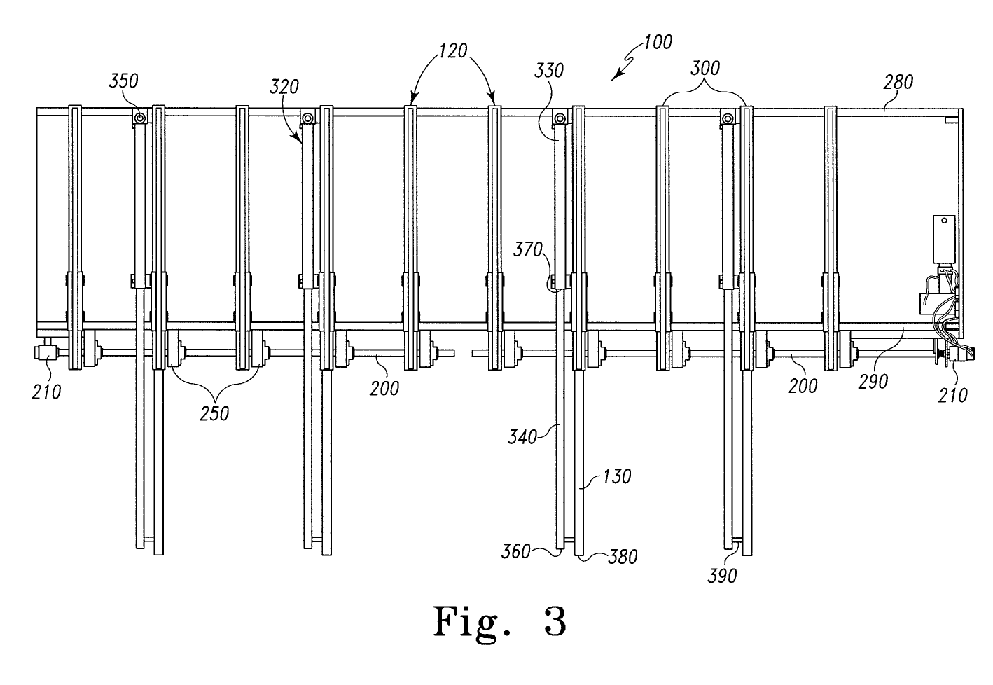

The side dismount apparatus 100 may further comprise at least one piston assembly 320. The at least one piston assembly 320 may comprise a piston housing 330, a piston 340, and a piston movement mechanism 350. When the at least one piston assembly 320 is in a “retracted” position (as shown in FIG. 1), the piston 340 would be substantially positioned within the piston housing 330 by the piston movement mechanism 350 operably coupled to the at least one piston assembly 320. When the at least one piston assembly 320 is in an “extended” position (as shown in FIGS. 2 and 3), the piston 340 would be substantially extended from the piston housing 330 by a piston movement mechanism 350. Operation of the piston movement mechanism 350 in a first direction may extend the piston 340 from the piston housing 330. Conversely, operation of piston movement mechanism 350 in a second direction opposite the first direction may retract the piston 340 into the piston housing 330. The piston movement mechanism 350 may comprise any number of mechanisms known in the art, including the use of compressed air, hydraulic fluid, and/or a motor.

The piston 340 may comprise a first end 360 and a second end 370 (as shown in FIGS. 2 and 3). The first end 360 of the piston 340 may be removably or fixedly coupled to a first end 380 of the inner arm 130, allowing the first end 380 of the piston 340 to be extended from the piston housing 330 while the first end 380 of the inner arm 130 is extended from the outer arm 140. Conversely, if the first end 360 of the piston 340 is coupled to the first end 380 of the inner arm 130, and the piston 340 is in a extended position along with the inner arm 130, the first end 360 of the piston 340 may be retracted into the piston housing 330 while the first end 380 of the inner arm 130 is retracted into the outer arm 140. In this fashion, movement of the piston 340 within the piston housing 330 may control the movement of the inner arm 130 within the outer arm 140.

As shown in FIG. 1, the embodiment of the side dismount apparatus 100 is in a fully retracted position. FIG. 2 shows an embodiment of the side dismount apparatus 100 with two of the inner arms 130 of the telescoping arm assemblies 120 extended outward from the side dismount apparatus 100. FIG. 3 shows an embodiment of the side dismount apparatus 100 with the inner arms 130 of four of the telescoping arm assemblies 120 extended outward from the side dismount apparatus 100. As the embodiments of the side dismount apparatus 100 shown in FIGS. 1-3 comprise two drive shafts 200 and two motors 210, allowing for some, but not all, of the inner arms 130 of the telescoping arm assemblies 120 having a piston 340 coupled to a first end 380 of the inner arm 130 to extend outward from the side dismount apparatus 100, while also allowing for all of the inner arms 130 of the telescoping arm assemblies 120 having a piston 340 coupled to a first end 380 of the inner arm 130 to extend outward from the side dismount apparatus 100.

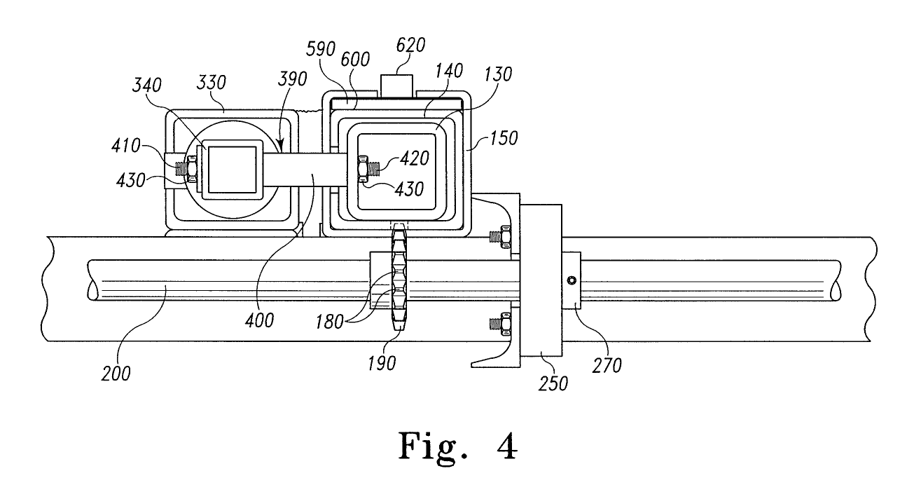

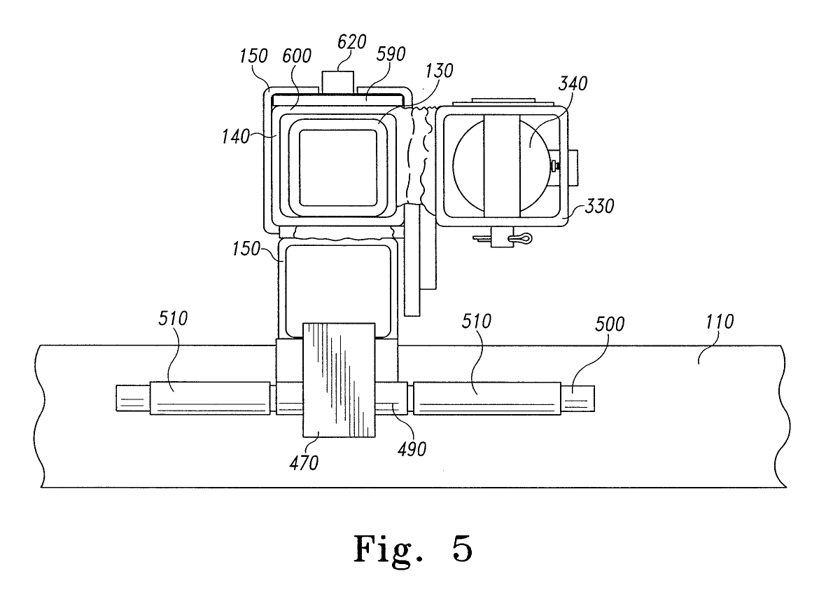

An embodiment of a piston 340 coupled to an inner arm 130 is shown in FIG. 4. In this embodiment, a piston 340 is positioned within a piston housing 330, and an inner arm 130 is positioned within an outer arm 140, with the outer arm 140 positioned within a lower channel arm 150. In this embodiment, the piston 340 is coupled to the inner arm 130 using a joining member 390 removably coupled to the piston 340 and the inner arm 130. In this embodiment, the joining member 390 comprises a shaft portion 400, a first portion 410, and a portion 420, wherein the first portion 410 of the joining member 390 is coupled to an opening (not shown) in the piston 340 and secured by a nut 430, and the second portion 420 of the joining member 390 is coupled to an opening (not shown) in the inner arm 130 and secured by a nut 430. In an exemplary embodiment, the first portion 410 and the second portion 420 of the joining member 390 are threaded. Other means of coupling a piston 340 to an inner arm 130 may be used, including but not limited to, the use of a joining member 390 with a first portion 410 and a second portion 420, a joining member 390 with openings to allow for locking pins, a joining member 390 that directly threads into a piston 340 and an inner arm 130, welding a joining member 390 to a portion of a piston 340 and a portion of an inner arm 130, and welding a portion of a piston 340 to a portion of an inner arm 130 (as shown in FIG. 5).

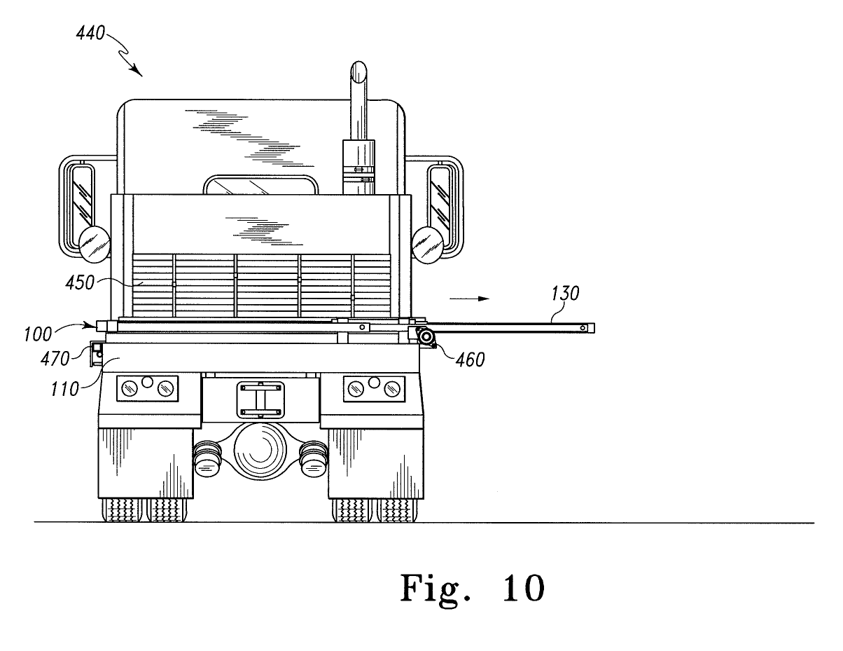

Referring now to FIG. 9, an embodiment of a side dismount apparatus 100 is shown on the trailer bed 110 of a transport vehicle 440. Construction materials 450 are shown positioned on top of the side dismount apparatus 100. As shown in FIG. 10, one or more inner arms 130 are extending from the telescoping arm assemblies 120. An inner arm 130 may be extended by the operation of at least one piston assembly 320 as discussed herein. The inner arm 130 and/or the outer arm 140 may extend over a silt fence and/or coconut logs (not shown) that are positioned at or near the perimeter of the construction site property for erosion control as discussed herein.

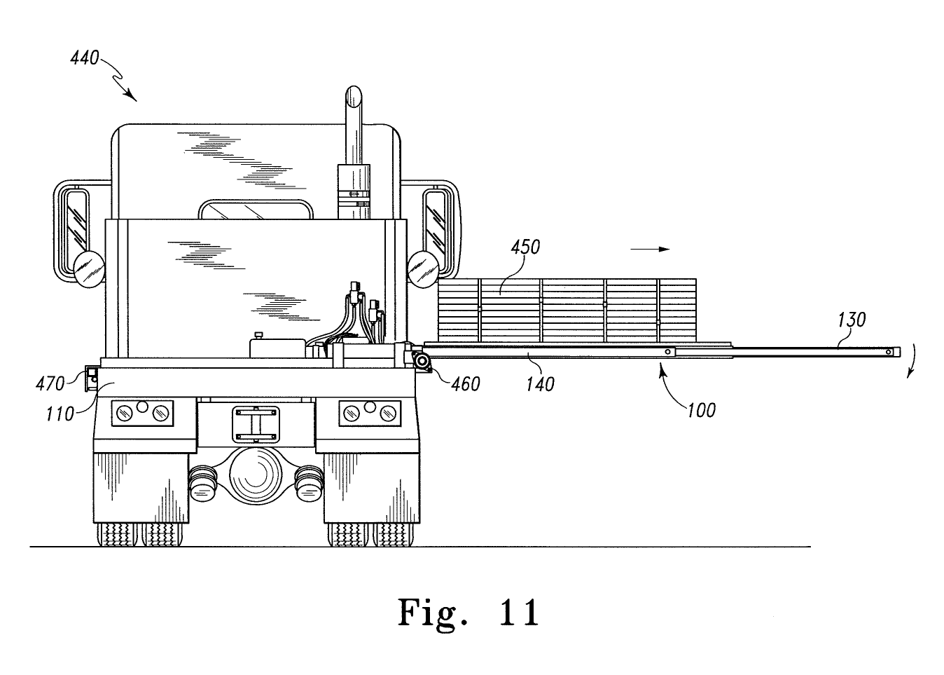

As shown in FIG. 11, one or more outer arms 140 are extending from the telescoping arm assemblies 120. An outer arm 140 may be extended by the operation of a motor 210 as discussed herein.

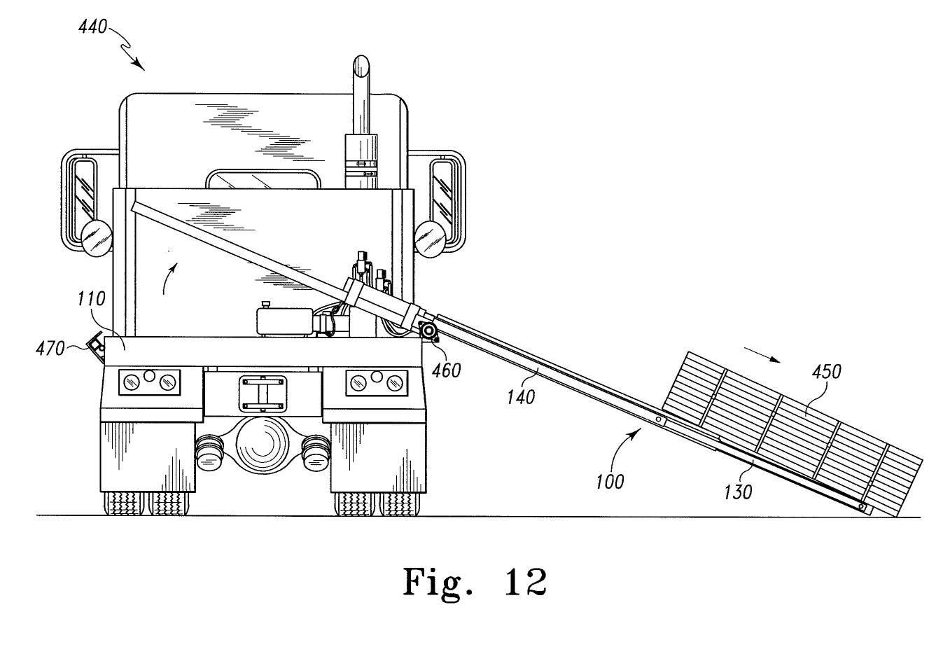

As shown in FIG. 12, at least one hinge 460 is shown coupled to the trailer bed 110 and the telescoping arm assemblies 120. The at least one hinge 460 allows for the telescoping arm assemblies 120 to pivot around the at least one hinge 460. An embodiment of the side dismount apparatus 100 may comprise a locking clip 470. In an embodiment comprising the locking clip 470, the at least one hinge 460 may pivot only when the locking clip 470 is disengaged. The telescoping arm assemblies 120 may pivot around the at least one hinge 460 due to the gravitational pull on the telescoping arm assemblies 120. FIGS. 4 and 7-12 show embodiments of the present disclosure comprising a locking clip 470, but it is understood that other embodiments of the present disclosure may not comprise a locking clip 470. In an embodiment not comprising a locking clip 470, the side dismount apparatus 100 may rest on a trailer bed 110 by the use of gravity.

Referring now to FIGS. 5 and 7, a locking clip 470 is shown in an engaged position. The locking clip 470 may be coupled to a spacer 480 which may be coupled to an outer pivot cylinder 490. Locking clip 470 may be coupled to an outer pivot cylinder 490 by other means. The outer pivot cylinder 490 may be positioned around and coupled to a pivot bar 500. The pivot bar 500 may be rotatably positioned within a stationary cylinder 510 coupled to the side of the trailer bed 110. A clip piston assembly (not shown) may be coupled to and positioned below the trailer bed 110, and may include a clip piston housing (not shown) and a clip piston 540 positioned within the clip piston housing. As shown in FIG. 7, the clip piston 540 is in an extended position, contacting the inner surface 550 of the locking clip 470. When the clip piston 540 is in an extended position, a first end 560 of the locking clip 470 is positioned within the lower channel arm 150, preventing the lower channel arm 150 from moving upwards. Locking clip 470 may also be coupled directly to the side of a trailer bed 110.

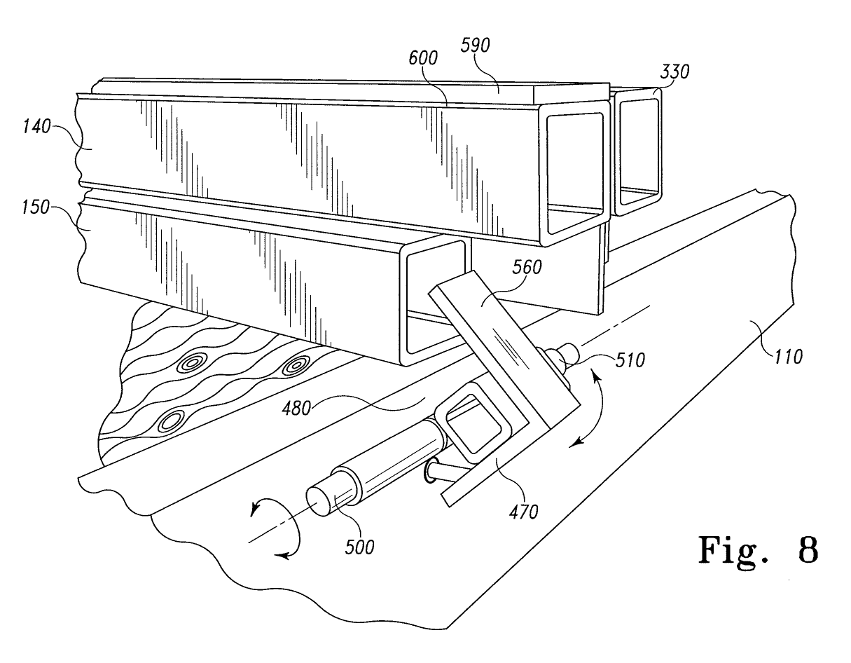

Referring now to FIG. 8, the locking clip 470 is shown in a disengaged position. The locking clip 470 may be disengaged by retracting the clip piston 540 within the clip piston housing so that the clip piston 540 no longer either contacts the inner surface 550 of the locking clip 470 or continues to contact the inner surface 550 of the locking clip 470 but still allowing the locking clip 470 to pivot about the outer pivot cylinder 490 (as shown). When the clip piston 540 is in a retracted position, the locking clip 470 may pivot about the outer pivot cylinder 490, whereby the first end 560 of the locking clip 470 is no longer positioned within the lower channel arm 150.

Referring back to FIG. 12, when the locking clip 470 is disengaged, the weight of the construction materials 450 on the telescoping arm assemblies 120 may cause the telescoping arm assemblies 120 to pivot about the at least one hinge 460, causing the first end 380 of the inner arm 130 to touch the ground or the surface to receive the construction materials 450. As the telescoping arm assemblies 120 pivots about the at least one hinge 460, the construction materials 450 may slide (as indicated by the arrow above the construction materials 450 in FIG. 12) toward the ground or the surface to receive the construction materials 450.

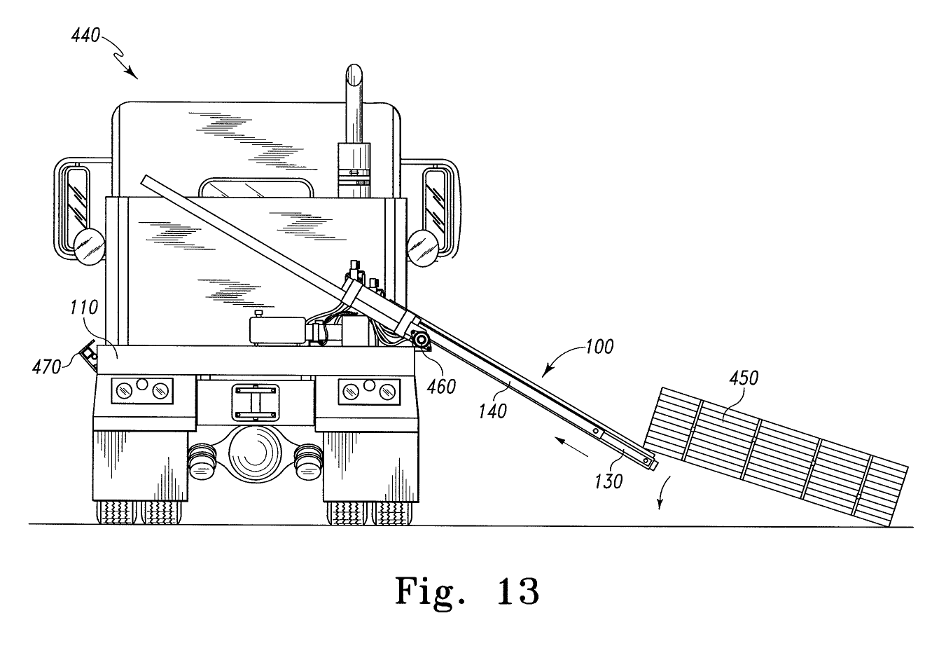

Referring now to FIG. 13, an embodiment of the side dismount apparatus 100 is shown whereby the inner arm 130 and/or the outer arm 140 are being retracted (as indicated by the arrow below the telescoping arm assemblies 120 in FIG. 13) to deposit the construction materials 450 onto the ground or the surface to receive the construction materials 450. The inner arm 130 may be retracted by the operation of the at least one piston assembly 320 as discussed herein, and the outer arm 140 may be retracted by the operation of a motor 210 also as discussed herein. As the inner arm 130 and/or the outer arm 140 are retracting, the construction materials 450 may move toward the ground or the surface to receive the construction materials 450 (as indicated by the arrow below the construction materials 450 in FIG. 13).

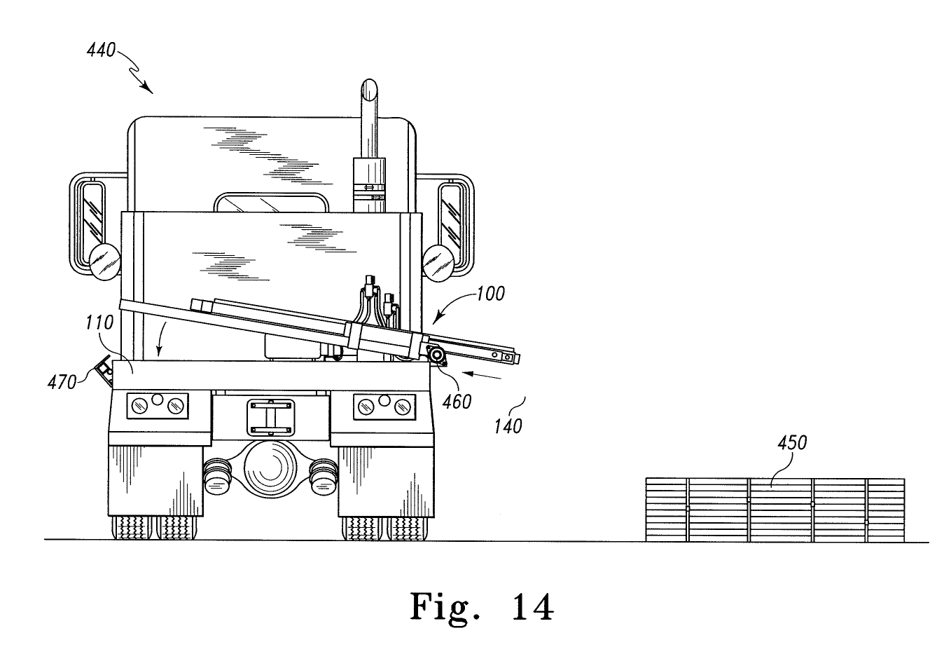

Referring now to FIG. 14, an embodiment of the side dismount apparatus 100 is shown whereby the inner arm 130 and/or the outer arm 140 are being retracted and lowered back onto the trailer bed 110 of the transport vehicle 440 (as indicated by the two arrows in FIG. 14). Once the inner arm 130 and/or the outer arm 140 is retracted to where the inner arm 130 and/or the outer arm 140 no longer contact the construction materials 450, the construction materials 450 may rest on the ground or the surface to receive the construction materials 450.

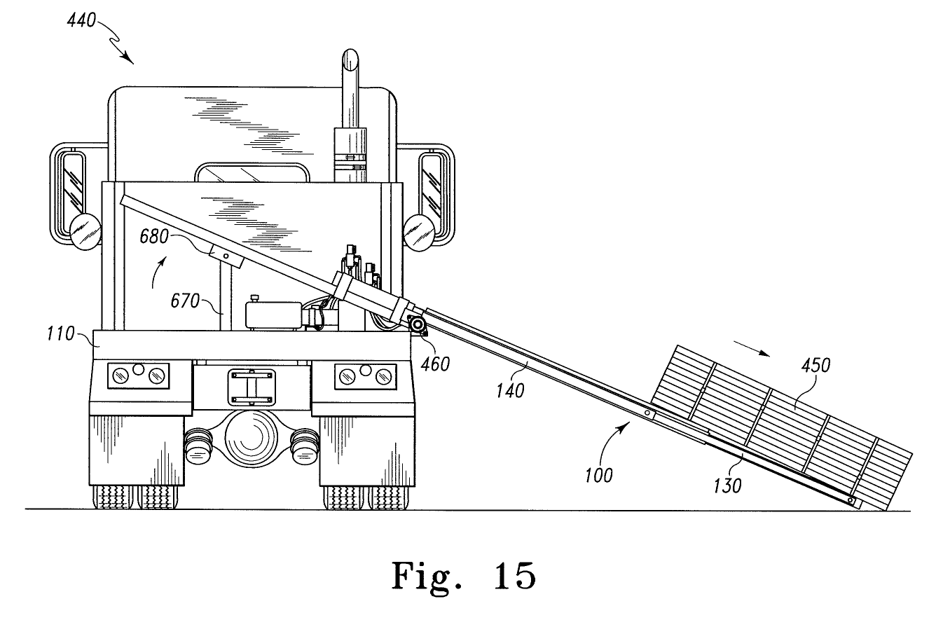

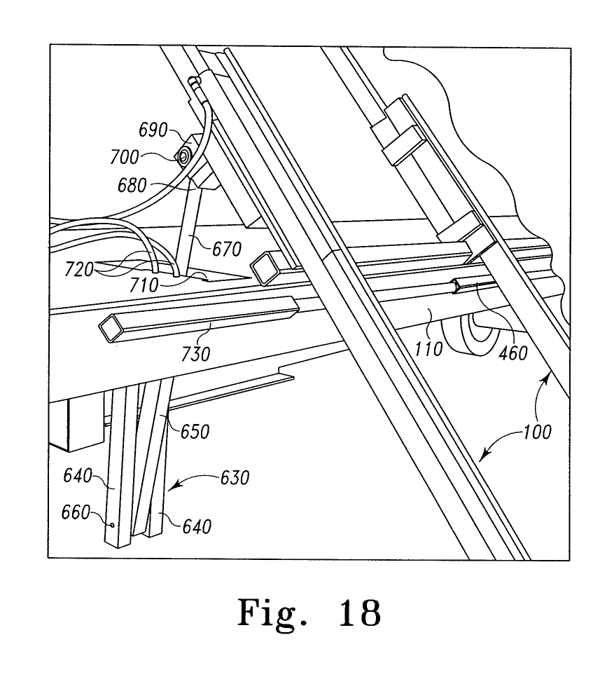

Referring now to FIGS. 15-18, an embodiment of the side dismount apparatus 100 is shown comprising a dismount piston assembly 630. Referring to FIG. 18, the dismount piston assembly 630 is shown comprising at least one support member 640 and a dismount piston housing 650. In the embodiment shown in FIG. 18, the dismount piston assembly 630 comprises two support members 640. The at least one support member 640 may be hingedly coupled to the dismount piston housing 650 using a pin 655 (not shown) placed through apertures 660 in one or both of the at least one support member 640 and the dismount piston housing 650. The at least one support member 640 and the dismount housing 650 may be positioned so that the apertures 660 provided therein would align to allow the pin 655 to be inserted therethrough. The dismount piston assembly 630 may be coupled to the lower surface of the trailer bed 110 as shown in FIG. 18.

The dismount piston housing 650 may comprise a dismount piston 670 slidingly engaged within the dismount piston housing 650. The dismount piston 670 comprises a first end 680 and a second end (not shown), the first end 680 hingedly coupled to an assembly bracket 690 coupled to at least one of the telescoping arm assemblies 120, and the second end slidingly engaged within the dismount piston housing 650. The first end 680 of the dismount piston 670 may be hingedly coupled to the assembly bracket 690 using a pin 695 (not shown) placed through apertures 700 in the assembly bracket 690. The first end 680 of the dismount piston 670 and the assembly bracket 690 may be positioned so that the apertures 700 provided therein would align to allow the pin 695 to be inserted therethrough. The assembly bracket may be coupled to the telescoping arm assemblies 120 at the outer arm 140, the lower channel arm 150, or another location of the telescoping arm assemblies 120 suitable for the purpose of raising and lowering the telescoping arm assemblies 120 about the at least one hinge 460. If a dismount piston assembly 640 is coupled to the lower surface of the trailer bed 110, the dismount piston housing 650, the dismount piston 670, and/or the assembly bracket 690 may, during some point during the extension of the dismount piston 670 from the dismount piston housing 650, be positioned within a trailer bed aperture 710.

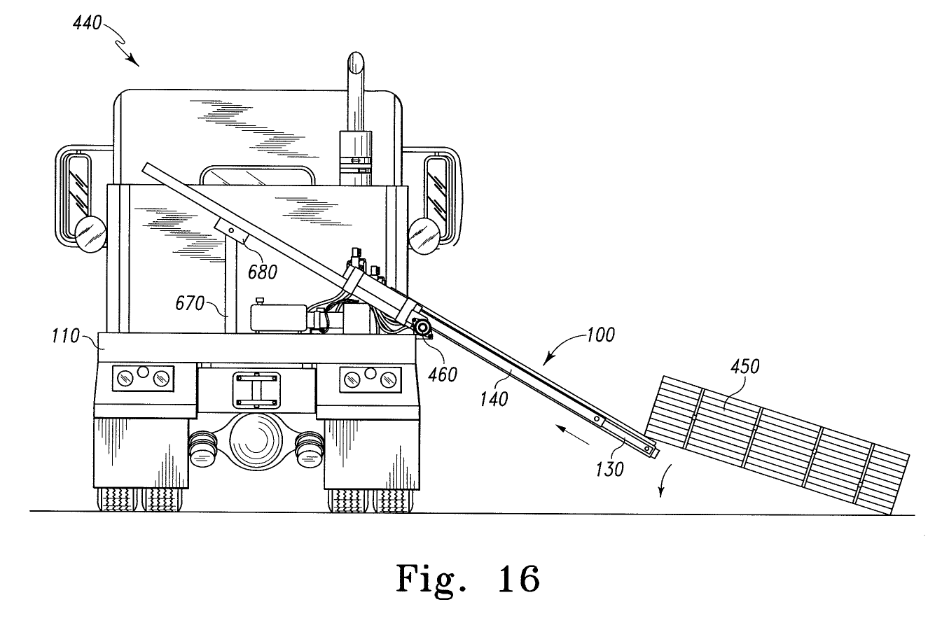

When the dismount piston assembly 630 is in a “retracted” position, the dismount piston 670 would be substantially positioned within the dismount piston housing 650 by a dismount piston movement mechanism (not shown). When the dismount piston assembly 630 is in an “extended” position (as shown in FIG. 16), the dismount piston 670 would be substantially extended from the dismount piston housing 650 by the dismount piston movement mechanism. Operation of the dismount piston movement mechanism in a first direction may extend the dismount piston 670 from the dismount piston housing 650. Conversely, operation of the dismount piston movement mechanism in a second direction opposite the first direction may retract the dismount piston 670 into the dismount piston housing 650.

The dismount piston movement mechanism may comprise any number of mechanisms known in the art, including the use of compressed air, hydraulic fluid, and/or a motor. In an embodiment of a dismount piston movement mechanism that utilizes compressed air or hydraulic fluid, the dismount piston movement mechanism may be coupled to the dismount piston assembly 630 by the use of hoses 720 that may contain compressed air or hydraulic fluid to allow the dismount piston movement mechanism to control the dismount piston assembly 630 as disclosed herein.

Referring to the embodiment shown in FIG. 15, the dismount piston 670 is shown extending from the dismount piston assembly 630 (not shown) from the trailer bed 110 to the assembly bracket 690 coupled to at least one of the telescoping arm assemblies 120. As the dismount piston 670 is extended from the dismount piston housing 650, the telescoping arm assemblies 120 may pivot about the at least one hinge 460, causing the first end 380 of the inner arm 130 to touch the ground or the surface to receive the construction materials 450. As the telescoping arm assemblies 120 pivots about the at least one hinge 460, the construction materials 450 may slide (as indicated by the arrow above the construction materials 450 in FIG. 15) toward the ground or the surface to receive the construction materials 450.

Referring now to FIG. 16, an embodiment of the side dismount apparatus 100 is shown whereby the inner arm 130 and/or the outer arm 140 are being retracted (as indicated by the arrow below the telescoping arm assemblies 120 in FIG. 16) to deposit the construction materials 450 onto the ground or the surface to receive the construction materials 450. The inner arm 130 may be retracted by the operation of the at least one piston assembly 320 as discussed herein, and the outer arm 140 may be retracted by the operation of a motor 210 also as discussed herein. As the inner arm 130 and/or the outer arm 140 are retracting, the construction materials 450 may move toward the ground or the surface to receive the construction materials 450 (as indicated by the arrow below the construction materials 450 in FIG. 16).

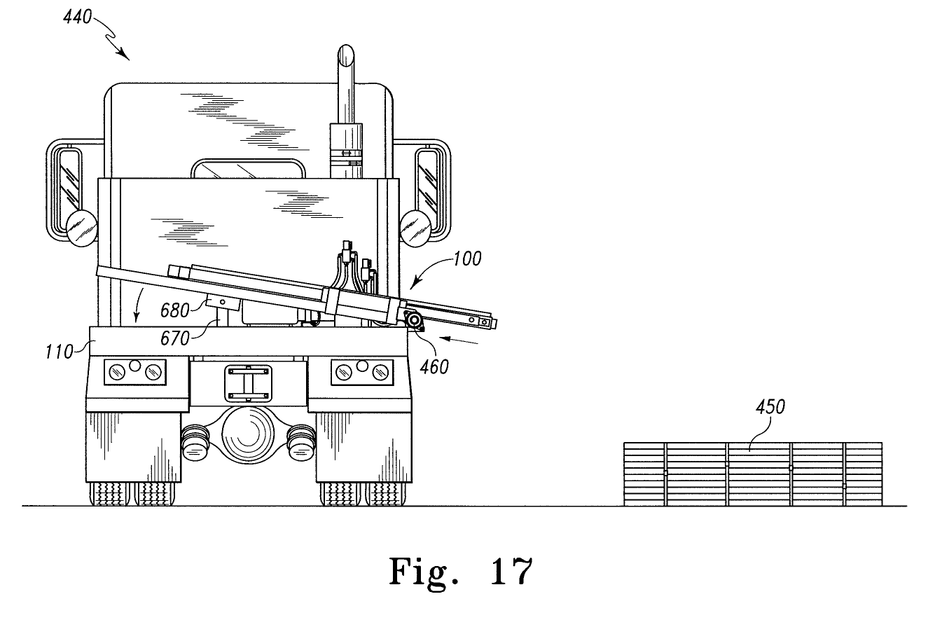

Referring now to FIG. 17, an embodiment of the side dismount apparatus 100 is shown whereby the inner arm 130 and/or the outer arm 140 are being retracted and lowered back onto the trailer bed 110 of the transport vehicle 440 (as indicated by the two arrows in FIG. 17). Retraction of the dismount piston 670 into the dismount piston housing 650 may facilitate the lowering of the telescoping arm assemblies 120 back onto the trailer bed 110. Once the inner arm 130 and/or the outer arm 140 is retracted to where the inner arm 130 and/or the outer arm 140 no longer contact the construction materials 450, the construction materials 450 may rest on the ground or the surface to receive the construction materials 450.

According to at least one embodiment of the present disclosure, the telescoping arm assemblies 120 may not comprise an inner arm 130. If the telescoping arm assemblies 120 do not comprise an inner arm 130, an embodiment of the side dismount apparatus 100 without an inner arm 130 may still function as described herein, but the steps involving the extension and retraction of the inner arm 130 from the telescoping arm assemblies 120 would be omitted. For example, and referring to FIG. 12, if an embodiment of a side dismount apparatus 100 did not include an inner arm 130, the outer arm 140 of the telescoping arm assemblies 120 would touch the ground or the surface to receive the construction materials 450.

According to at least one embodiment of the present disclosure, a load platform 590 may be fixedly or removably coupled to a top surface 600 of the outer arm 140 (as shown in FIGS. 4-8). The load platform 590 may allow for the construction materials 450 to rest directly on the load platform 590 instead of resting directly on the top surface 600 of the outer arm 140. The load platform 590 be composed from any number of suitable load-bearing materials, including but not limited to, metal, wood, or plastic. A load bar 620 may also be fixedly or removably coupled to the load platform 590 as shown in FIGS. 4-6. The load bar 620 may be sized and shaped to allow for the outer arm 140 to extend and/or retract within the lower channel arm 150 while also allowing for the construction materials 450 to directly rest on the load bar 620 instead of resting directly on the load platform 590 or the top surface 600 of the outer arm 140. The load bar 620 be composed from any number of suitable load-bearing materials, including but not limited to, metal, wood, or plastic.

According to at least one embodiment of the present disclosure, an assembly bar 730 may be coupled to the telescoping arm assemblies 120 as shown in FIG. 18. In such an embodiment, the assembly bar 730 and/or at least one of the telescoping arm assemblies 120 may comprise at least one hinge 460, whereby movement of at least one of the telescoping arm assemblies 120 about the at least one hinge 460 would result in the movement of any other telescoping arm assemblies 120 that may be coupled to the assembly bar 730.

According to at least one embodiment of the present disclosure, the side dismount apparatus 100 may be positioned on a trailer bed 110 of a transport vehicle 440 to allow for the unloading of any number construction materials 450 or other materials, including but not limited to, trusses, shingles, windows, doors, lumber, cabinetry, appliances, bricks, and cinderblocks.

According to at least one embodiment of the present disclosure, the side dismount apparatus 100 as referenced herein may function as described herein but without the use of at least one piston assembly 320. In such an embodiment, the inner arm 130 may be extended or retracted manually or with the use of a gear 190, drive shaft 200, and motor 210 as disclosed herein with respect to movement of the outer arm 140. The inner arm 130 may also be extended or retracted using other means known in the art for moving an inner arm 130 as described herein.

According to at least one embodiment of the present disclosure, the side dismount apparatus 100 as referenced herein may function as described herein but without the use of a gear 190, drive shaft 200, and motor 210 as disclosed herein. It can be appreciated that at least one piston assembly 320 as described herein with reference to extending and retracting the inner arm 130 may be used to extend and retract the outer arm 140 as described herein.

In view of the many possible embodiments to which the principles of the disclosure herein may be applied, it should be recognized that the detailed embodiments are illustrative only and should not be taken as limiting the scope of the disclosure. The disclosure can be further modified within the scope and spirit of this information contained herein. This application is therefore intended to cover any variations, uses, or adaptations of the disclosure using its general principles. Further, this application is intended to cover such departures from the present disclosure as come within known or customary practice in the art to which the disclosure pertains and which fall within the limits of the appended claims.

I claim:

1. A side dismount apparatus for unloading construction materials from the side of a transport vehicle, the side dismount apparatus comprising:
at least two telescoping arm assemblies, the at least two telescoping arm assemblies each comprising an outer arm having a lower surface and a lower arm, the lower surface of the outer arm slidingly engaged with the lower arm;
a rotatable substantially cylindrical drive shaft having a longitudinal axis; and
a gear concentric with the longitudinal axis of the drive shaft so that rotation of the drive shaft rotates the gear, the gear comprising teeth for engaging the lower surface of the outer arm of at least one of the at least two telescoping arm assemblies, whereby rotation of the drive shaft is operable to extend and retract the outer arm from at least one of the at least two telescoping arm assemblies.

2. The side dismount apparatus of claim 1, wherein each of the at least two telescoping arm assemblies further comprises an inner arm positioned within the outer arm.

3. The side dismount apparatus of claim 2, further comprising at least one piston assembly coupled to at least one of the at least two telescoping arm assemblies, the at least one piston assembly comprising:
a piston housing;
a piston coupled to the inner arm and positioned within the piston housing; and
a piston movement mechanism operably coupled to the at least one piston assembly.

4. The side dismount apparatus of claim 1, wherein the lower surface of at least one of the outer arms defines gear apertures sized and shaped to receive the teeth of the gear.

5. The side dismount apparatus of claim 1, further comprising individual chain links coupled to the lower surface of at least one of the outer arms, the individual chain links defining individual chain apertures, the individual chain apertures sized and shaped to receive the teeth of the gear.

6. The side dismount apparatus of claim 1, further comprising a motor operable to rotate the drive shaft.

7. The side dismount apparatus of claim 1, wherein the side dismount apparatus is removably coupled to the transport vehicle.

8. The side dismount apparatus of claim 7, further comprising a dismount piston assembly coupled to a transport vehicle.

9. The side dismount apparatus of claim 1, further comprising at least one hinge coupled to at least one of the at least two telescoping arm assemblies.

10. The side dismount apparatus of claim 3, further comprising a joining member comprising:
a shaft portion;
a first portion of the shaft portion coupled to a first end of the piston; and
a second portion of the shaft portion coupled to a first end of the inner arm.

11. A transport vehicle for unloading construction materials from the side of the transport vehicle, the transport vehicle comprising:
a side dismount apparatus removably coupled to the transport vehicle, the side dismount apparatus comprising at least two telescoping arm assemblies, the at least two telescoping arm assemblies each comprising an outer arm having a lower surface and a lower arm, the lower surface of the outer arm slidingly engaged with the lower arm;
a rotatable substantially cylindrical drive shaft having a longitudinal axis; and
a gear concentric with the longitudinal axis of the drive shaft so that rotation of the drive shaft rotates the gear, the gear comprising teeth for engaging the lower surface of the outer arm of at least one of the at least two telescoping arm assemblies.

12. The transport vehicle of claim 11, wherein each of the at least two telescoping arm assemblies further comprises an inner arm positioned within the outer arm.

13. The transport vehicle of claim 12, further comprising at least one piston assembly coupled to at least one of the at least two telescoping arm assemblies, the at least one piston assembly comprising:
a piston housing;
a piston coupled to the inner arm and positioned within the piston housing; and
a piston movement mechanism operably coupled to the at least one piston assembly.

14. The transport vehicle of claim 11, wherein the lower surface of the outer arm defines gear apertures sized and shaped to receive the teeth of the gear.

15. The transport vehicle of claim 11, further comprising a motor operable to rotate the drive shaft.

16. The transport vehicle of claim 11, further comprising at least one support member, the at least one support member defining an inner surface sized and shaped to rotatably receive the drive shaft.

17. The transport vehicle of claim 11, further comprising at least one hinge coupled to at least one of the at least two telescoping arm assemblies.

18. The transport vehicle of claim 11, further comprising a dismount piston assembly coupled to the transport vehicle.

19. The transport vehicle of claim 11, further comprising a locking clip coupled to the transport vehicle.

20. A transport vehicle for unloading construction materials from the side of the transport vehicle, the transport vehicle comprising:
a side dismount apparatus removably coupled to the transport vehicle, the side dismount apparatus comprising:
at least two telescoping arm assemblies, the at least two telescoping arm assemblies each comprising:
an outer arm having a lower surface;
a lower arm slidingly engaged with the lower surface of the outer arm; and
an inner arm positioned within the outer arm;
at least one piston assembly coupled to at least one of the at least two telescoping arm assemblies, the at least one piston assembly comprising:
a piston housing;
a piston coupled to the inner arm and positioned within the piston housing; and
a piston movement mechanism operably coupled to the at least one piston assembly;
a rotatable substantially cylindrical drive shaft having a longitudinal axis;
at least one support member, the at least one support member defining an inner surface sized and shaped to rotatably receive the drive shaft;
a gear concentric with the longitudinal axis of the drive shaft so that rotation of the drive shaft rotates the gear, the gear comprising teeth for engaging the lower surface of the outer arm of at least one of the at least two telescoping arm assemblies;
a motor operable to rotate the drive shaft;
at least one hinge coupled to at least one of the at least two telescoping arm assemblies; and
a dismount piston assembly coupled to the transport vehicle.
